(19) United States
(12) Patent Application Publication
(10) Pub. No.: US 2025/0153446 A1
(43) Pub. Date: May 15, 2025

(54) Apparatus for Producing an Interior Component, Method for Producing an Interior Component With the Apparatus and Interior Component

(71) Applicant: Bayerische Motoren Werke Aktiengesellschaft, Muenchen (DE)

(72) Inventors: Thomas AUMANN, Buch am Erlbach (DE); Florian DECHANT, Adlkofen (DE); Johann GASSLHUBER, Buch am Erlbach (DE)

(21) Appl. No.: 18/941,385

(22) Filed: Nov. 8, 2024

(30) Foreign Application Priority Data
Nov. 10, 2023 (DE) 10 2023 131 241.3

(51) Int. Cl. B29C 65/78; B29L 31/30; D05B 35/00

(52) U.S. Cl. CPC B29C 65/78; D05B 35/00; B29L 2031/3005

(57) ABSTRACT

An apparatus for producing an interior component from a carrier element and a top layer includes a handling device, a component support for receiving the carrier element and the top layer, where the component support has a fixing device for temporarily fixing the carrier element and the top layer on the component support, a welding head, and a sewing head. A control unit controls the handling device where a data set for controlling at least the handling device in a manner dependent on a material of the top layer is stored in the control unit and where the handling device is controllable depending on the material of the top layer by the control unit such that, to connect the top layer to the carrier element, the top layer and the carrier element are welded by the welding head or sewn by the sewing head.

### CROSS REFERENCE TO RELATED APPLICATION

This application claims priority under 35 U.S.C. § 119 from German Patent Application No. DE 10 2023 131 241.3, filed Nov. 10, 2023, the entire disclosure of which is herein expressly incorporated by reference.

### BACKGROUND AND SUMMARY

The invention relates to an apparatus for producing an interior component, to a method for producing an interior component with the apparatus and to an interior component.

One of the aims in the context of the circular economy is that the plastics materials of an interior component of a motor vehicle are separable from a top layer of the interior component in the future. Foamed or firmly bonded surface materials are counterproductive for this. Exchangeable surface materials are also advantageous for the customizability in the interior and the ability to exchange damaged surfaces.

In the prior art, molded skins are generated in an inseparable and also exchangeable manner via skin/foam/carrier systems. Surfaces such as leather, artificial leather and textiles are firmly and no longer reversibly laminated to carrier parts by means of laminating adhesive.

Detachable surface coverings have so far not been used in large-area cockpit regions. Thus, a subsequent customization or an exchange in the case of damage is possible only by exchanging the entire assembly, if at all. After the life cycle of the vehicle, a type-specific separation of the plastics qualities is therefore not able to be realized. An inferior mixed plastic is generated by shredding, or the components have to be disposed of thermally.

In addition, in the case of known production apparatuses, the various process steps for different top layer materials and the resulting manufacturing tolerances mean that no repeatable and reproducible interior components with a carrier element and a top layer to be arranged on the carrier element can be produced, in particular owing to the fact that for example knitted fabrics are very stretchy and thermoplastic olefins and artificial leather are very stiff.

The invention is therefore based on the object of overcoming the aforementioned disadvantages and of providing an apparatus for producing an interior component, a method for producing an interior component with the apparatus and an interior component, in which connecting of a carrier element to a top layer in a manner dependent on the material of the top layer is ensured in a reliable and reproducible manner.

The basic concept of the present invention is first of all to implement a combination of sewing and welding processes in a common apparatus for producing the interior component by means of a handling device or by means of robot application.

By way of a robot process and an intelligent component receptacle or component support which is adapted individually to the respective material property, the different mechanical properties of the surface materials to be processed can be represented in a reliable and repeatable manner. The required fixing is able to be carried out by way of a welding and/or sewing process in a manner dependent on the material property of the top layer. On the component support or a multi-receptacle, top layers or coverings of different materials are connected to the carrier element in one process, for example by way of the handling device or a robot. Depending on the material of the top layer, the handling device is capable of implementing the suitable fastening method owing to a welding head, in particular an ultrasonic welding head, with a welding apparatus and a sewing head with a sewing apparatus. In this way, a connection between the carrier element and the top layer is formed which is separable, in particular completely, at the end of a life cycle of the interior component. In addition, manufacturing steps during the production method are saved.

The invention therefore provides an apparatus for producing an interior component, in particular of a motor vehicle, from a carrier element and a top layer to be arranged and/or to be fixed on the carrier element, comprising a handling device and a component support for receiving the carrier element and/or the top layer. A welding head, in particular an ultrasonic welding head, more particularly with a corresponding welding apparatus, and a sewing head, in particular with a sewing apparatus, are also provided for connecting the top layer to the carrier element. The handling device is also designed to receive and position the component support and/or the welding head and the sewing head. Furthermore, the component support has at least one fixing means for temporarily fixing the carrier element and/or the top layer on the component support. In addition, a control unit is provided for controlling the handling device. A data set for controlling at least the handling device in a manner dependent on a material of the top layer is stored in the control unit. The handling device is also controllable in a manner dependent on the material of the top layer by means of the control unit in such a way that, to connect the top layer to the carrier element, these are welded by means of the welding head or sewn by means of the sewing head.

In an advantageous embodiment variant, provision is made for the component support to have a receptacle for auxiliary components, in particular U-shaped members, preferably composed of a plastic and/or the material of the carrier element, for connecting the top layer to the carrier element. In this way, when producing the interior component with the apparatus, auxiliary components which can be used to adjust a preload of the top layer can additionally be connected to the interior component.

Preferably, the apparatus is designed in such a way that the component support has a first receiving surface for sewing and a second receiving surface, on the opposite side from the first receiving surface, for welding. The component support is also rotatable about a longitudinal axis of the component support, in particular by means of an electric motor, which is controllable by the control unit, on the basis of corresponding data stored in the data set.

In one exemplary embodiment of the invention, provision is made for the ultrasonic welding head and the sewing head to be detachably arranged on the handling device. Furthermore, in particular a tool carrier is provided for at least the one ultrasonic welding head and at least the one sewing head. However, it is also conceivable for multiple ultrasonic welding heads and/or sewing heads to be arranged on the tool carrier, which are then selectable in accordance with the material of the top layer to be arranged on the carrier element.

An embodiment in which a sensor system, arranged in particular on or in the region of the handling device, is provided for detecting a material of the top layer and a positioning of the top layer and of the carrier element is also favorable. The handling device is also controllable by means of the control unit on the basis of the data ascertained by the sensor system.

In a further advantageous variant, a further handling device is provided for receiving and positioning the carrier element and/or the top layer. However, depending on the embodiment of the handling device, it is also conceivable for only one handling device to be provided and for this to also be designed to receive and position the carrier element and/or the top layer. In one exemplary embodiment, the corresponding handling device is a multi-axis robot. Furthermore, in one embodiment variant, the fixing means is a hold-down means.

In a preferred embodiment of the invention, the welding head is an ultrasonic welding head with a sonotrode for ultrasonic welding.

The invention also provides a method for producing an interior component, in particular of a motor vehicle, from a carrier element and a top layer to be arranged on the carrier element, with an apparatus according to the disclosure above, in which the carrier element is arranged on the component support and the top layer is subsequently arranged on the carrier element or in which the carrier element together with the top layer already arranged on the carrier element is arranged, in particular by means of the further handling device. Furthermore, the carrier element and the top layer are fixed on the component support by means of the fixing means and the handling device is controlled in a manner dependent on a material of the top layer by means of the control unit in such a way that, to connect the top layer to the carrier element, these are welded by means of the welding head or sewn by means of the sewing head.

During the controlling, the handling device with the welding head and the sewing head is in particular moved to the rigidly or positionally fixedly arranged component support. As an alternative, it is in particular also conceivable that, during the controlling, the component support is moved by means of the handling device to a rigidly or positionally fixedly arranged welding head and/or sewing head. In addition, if a further handling device is provided, it is also possible, in particular during the controlling, for the welding head and the sewing head, by means of the handling device, and the component support, by means of the further handling device, to be moved toward one another.

In an advantageous exemplary embodiment, provision is made for a material of the top layer to be detected by means of the sensor system before, during or after the arranging.

Preferably, before the arranging, the component support is positioned in accordance with the material of the top layer that is ascertained with the sensor system, by means of the control unit, by a rotation of the component support.

In one embodiment variant of the method, provision is made for the top layer to be welded to an edge region, in particular an edge fold, of the carrier element.

In a preferred embodiment of the invention, the carrier element has protrusions composed of plastic which are welded to the top layer during the welding. Preferably, these are conical protrusions with a pointed end portion which penetrate the top layer when the top layer is being arranged on the carrier element.

In a further advantageous variant, provision is made according to the invention for sewing to be performed through the top layer and the carrier element during the sewing.

An embodiment in which sewing is performed in the case of a top layer composed of artificial leather and/or TPO foam sheet (foam sheet composed of thermoplastic olefins) and/or of nylon with a polyurethane coating and/or of PU foam sheet, in particular PU-ISF, is also favorable. Furthermore, welding is performed in the case of a textile top layer, in particular a knitted fabric.

In a further advantageous variant, provision is made according to the invention for a respective auxiliary component to be arranged in the at least one receptacle before the arranging. The auxiliary component is also welded or sewn to the top layer and/or the carrier structure.

Furthermore, the invention provides an interior component, in particular of a motor vehicle, produced by a method according to the disclosure above.

The features disclosed above can be combined as desired, insofar as this is technically possible and they are not mutually exclusive.

Other advantageous developments of the invention are characterized in the dependent claims or are illustrated in more detail below together with the description of the preferred embodiment of the invention on the basis of the FIGURE.

Other objects, advantages and novel features of the present invention will become apparent from the following detailed description of one or more preferred embodiments when considered in conjunction with the accompanying drawing.

### BRIEF DESCRIPTION OF THE DRAWING

The FIGURE shows a schematic view of an apparatus for producing an interior component with the interior component.

### DETAILED DESCRIPTION OF THE DRAWING

The FIGURE is illustrative and schematic.

The FIGURE illustrates a schematic view of an apparatus 100 for producing an interior component 1 with the interior component 1, produced by means of the apparatus 100, of a motor vehicle with a carrier element 11 and a top layer 12 fixed on the carrier element 11.

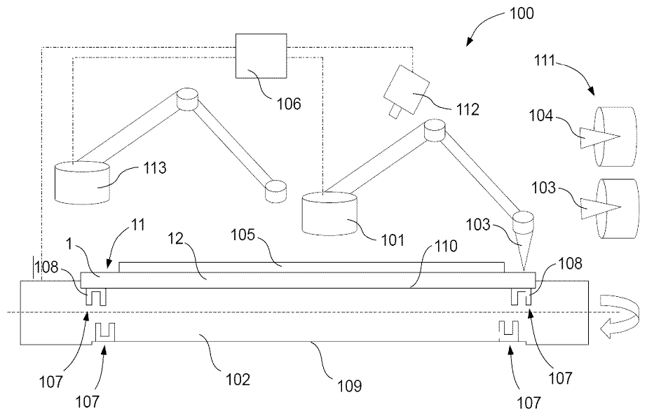

The apparatus 100 for producing the interior component 1 comprises a handling device 101 and a component support 102 for receiving the carrier element 11 and/or the top layer 12. A welding head 103, which is in the form of an ultrasonic welding head with a sonotrode for ultrasonic welding, and a sewing head 104 with a sewing apparatus are also provided for connecting the top layer 12 to the carrier element 11. The handling device 101 is also designed to receive and position the component support 102 and/or the welding head 103 and the sewing head 104. The welding head 103 and the sewing head 104 are detachably arranged on the handling device 101. A tool carrier 111 is also provided for at least the one ultrasonic welding head 103 and at least the one sewing head 104. In the exemplary embodiment shown in FIG. 1, a sewing head 104 and a welding head 103 are arranged in the tool carrier 111.

The component support 102 has a fixing means 105 for temporarily fixing the carrier element 11 and/or the top layer 12 on the component support 102, the fixing means being a hold-down means. In addition, the component support 102 has a receptacle 107 for auxiliary components 108, in the illustrated variant a U-shaped member composed of plastic, for connecting the top layer 12 to the carrier element 11. A respective auxiliary component 108 is arranged in the corresponding receptacle 107 before the arranging. The auxiliary component 108 in FIG. 1 has also already been welded to the top layer 12 and/or the carrier structure 11.

Furthermore, the component support 102 has a first receiving surface 109 for sewing and a second receiving surface 110, on the opposite side from the first receiving surface 109, for welding. The component support 102 is also rotatable about a longitudinal axis of the component support 102 by means of an electric motor which is controllable by a control unit 106. Before the arranging, the component support 102 is positionable in accordance with the material of the top layer 12 that is ascertained with the sensor system, by means of the control unit 106, by a rotation. Since in the FIGURE the top layer 12 is or has been welded to the carrier element 11, the interior component 1 is arranged on the second receiving surface 110.

The control unit 106 is also provided for controlling the handling device 101. A data set for controlling at least the handling device 101 in a manner dependent on a material of the top layer 12 is stored in the control unit 106. Here, the handling device 101 is controllable in a manner dependent on the material of the top layer 12 by means of the control unit 106 in such a way that, to connect the top layer 12 to the carrier element 11, these are welded by means of the ultrasonic welding head 103 or sewn by means of the sewing head 104.

The apparatus 100 shown in the FIGURE additionally has a sensor system 112 for detecting a material of the top layer 12 and a positioning of the top layer 12 and of the carrier element 11 in the region of the handling device 101. The handling device 101 is also controllable by means of the control unit 106 on the basis of the data ascertained by the sensor system 112.

A further handling device 113 is also provided for receiving and positioning the carrier element 11 and/or the top layer 12 and is also controllable on the basis of data stored in the control unit 106 for controlling the further handling device 113. The respective handling device 101, 113 is a multi-axis robot.

The interior component 1 is welded to an edge region, in particular an edge fold, of the carrier element 11. The carrier element 11 has protrusions composed of plastic which have been welded to the top layer 12 during the welding.

The top layer 12 of the interior component 1 is a textile top layer composed of a knitted fabric. In accordance with the data set stored in the control unit 106, according to which sewing is performed in the case of a top layer 12 composed of artificial leather and/or TPO foam sheet and/or of nylon with a polyurethane coating and/or PU foam sheet, in particular PU-ISF, and welding is performed in the case of a textile top layer 12, in particular a knitted fabric, the top layer 12 is welded to the carrier element 11.

The invention is not restricted in terms of its embodiment to the preferred exemplary embodiments specified above. Instead, there is a number of conceivable variants that make use of the solution presented even in fundamentally different types of embodiments.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for producing an interior component from a carrier element and a top layer, comprising:
a handling device;
a component support for receiving the carrier element and the top layer, wherein the component support has a fixing means for temporarily fixing the carrier element and the top layer on the component support;
a welding head;
a sewing head; and
a control unit for controlling the handling device, wherein a data set for controlling at least the handling device in a manner dependent on a material of the top layer is stored in the control unit and wherein the handling device is controllable depending on the material of the top layer by the control unit such that, to connect the top layer to the carrier element, the top layer and the carrier element are welded by the welding head or sewn by the sewing head.

2. The apparatus according to claim 1, wherein the component support has a receptacle for an auxiliary component for connecting the top layer to the carrier element.

3. The apparatus according to claim 1, wherein the component support has a first receiving surface on a first side of the component support for sewing and a second receiving surface on a second side the component support for welding, wherein the first side of the component support is opposite from the second side of the component support, and wherein the component support is rotatable about a longitudinal axis of the component support.

4. The apparatus according to claim 1, wherein the welding head and the sewing head are detachably disposed on the handling device and wherein a tool carrier is provided for the welding head and the sewing head.

5. The apparatus according to claim 1, further comprising a sensor system for detecting the material of the top layer and a positioning of the top layer and of the carrier element, wherein the handling device is controllable by the control unit on a basis of data ascertained by the sensor system.

6. A method for producing an interior component from a carrier element and a top layer with the apparatus according to claim 1, comprising the steps of:
arranging the carrier element on the component support and subsequently arranging the top layer on the carrier element or arranging the carrier element together with the top layer already arranged on the carrier element on the component support;
fixing the carrier element and the top layer on the component support by the fixing means; and
controlling the handling device in a manner dependent on a material of the top layer by the control unit such that, to connect the top layer to the carrier element, the top layer and the carrier element are welded by the welding head or sewn by the sewing head.

7. The method according to claim 6, wherein the material of the top layer is detected by a sensor system before, during, or after the arranging.

8. The method according to claim 6, wherein when the top layer and the carrier element are welded by the welding head, the carrier element has protrusions composed of plastic which are welded to the top layer.

9. The method according to claim 6, wherein the top layer and the carrier element are sewn when the top layer is composed of artificial leather or a foam sheet composed of thermoplastic olefins or of nylon with a polyurethane (PU) coating or of a PU foam sheet and wherein the top layer and the carrier element are welded when the top layer is a textile top layer.

10. The method according to claim 6, further comprising the steps of disposing an auxiliary component in a receptacle of the component support before the arranging and welding or sewing the auxiliary component to the top layer or the carrier structure.

11. An interior component of a motor vehicle produced by a method comprising the steps of:
arranging a carrier element on a component support and subsequently arranging a top layer on the carrier element or arranging the carrier element together with the top layer already arranged on the carrier element on the component support;
fixing the carrier element and the top layer on the component support by a fixing means; and
controlling a handling device in a manner dependent on a material of the top layer by a control unit such that, to connect the top layer to the carrier element, the top layer and the carrier element are welded by a welding head or sewn by a sewing head.
